(19) United States
(12) Patent Application Publication
(10) Pub. No.: US 2023/0263229 A1
(43) Pub. Date: Aug. 24, 2023

(54) AEROSOL GENERATION DEVICE AND INFRARED HEATER

(71) Applicant: SHENZHEN FIRST UNION TECHNOLOGY CO., LTD., Shenzhen City, Guangdong P (CN)

(72) Inventors: RUILONG HU, Shenzhen City, Guangdong Province (CN); WEI CHEN, Shenzhen City, Guangdong Province (CN); YINZHE LI, Shenzhen City, Guangdong Province (CN); ZHONGLI XU, Shenzhen City, Guangdong Province (CN); YONGHAI LI, Shenzhen City, Guangdong Province (CN)

(21) Appl. No.: 18/024,257

(22) PCT Filed: Sep. 1, 2021
(86) PCT No.: PCT/CN2021/116030

§ 371 Date: Mar. 1, 2023

(30) Foreign Application Priority Data
Sep. 1, 2020 (CN) 202010902708.1

(51) Int. Cl. A24F 40/46; A24F 40/20; H05B 3/06

(52) U.S. Cl. CPC A24F 40/46; A24F 40/20; H05B 3/06; H05B 2203/032; H05B 2203/007; H05B 2203/013

(57) ABSTRACT

The present application relates to the field of smoking devices, and provides an aerosol generation apparatus and an infrared heater. The aerosol generation apparatus comprises a chamber used for receiving an aerosol-forming substrate; and at least one infrared heater configured to radiate infrared rays to the chamber to heat the aerosol-forming substrate. The infrared heater comprises multiple infrared heating regions used for heating different parts of the aerosol-forming substrate, and predetermined spacing is maintained between adjacent infrared heating regions. The multiple infrared heating regions are configured to be non-independently started. According to the present application, the multiple infrared heating regions are non-independently started to heat the different parts of the aerosol-forming substrate, and because the predetermined spacing is maintained between adjacent infrared heating regions, the parts of the aerosol-forming substrate corresponding to the infrared heating regions have a significant temperature difference from the parts of the aerosol-forming substrate corresponding to the preset spacing, thereby avoiding the problem that the volatilization of cigarette components is relatively single, and improving the smoking experience of the user.

### CROSS-REFERENCE TO RELATED APPLICATIONS

This application claims priority to Chinese Patent Application No. 202010902708.1, filed with the China National Intellectual Property Administration on Sep. 1, 2020 and entitled “AEROSOL GENERATION DEVICE AND INFRARED HEATER”, which is incorporated herein by reference in its entirety.

### TECHNICAL FIELD

Embodiments of this application relate to the field of cigarette device technologies, and in particular, to an aerosol generation device and an infrared heater.

### BACKGROUND

During the use of smoking articles such as cigarettes or cigars, tobacco is burned to produce smoke. Attempts have been made to replace these tobacco-burning articles with products that release compounds without burning. An example of such products is a heat-not-burn product that releases compounds by heating rather than burning tobacco.

In an existing heat-not-burn cigarette device, a far-infrared coating and a conductive coating are mainly coated on an outer surface of a base body. The far-infrared coating is energized to emit a far-infrared ray to penetrate the base body and heat a cigarette in the base body. Because of the strong penetrability of the far-infrared ray, the far-infrared ray can penetrate a periphery of the cigarette and enter the interior, which makes the heating of an aerosol-forming substrate in the cigarette more uniform.

To meet physiological requirements of inhalation of consumers, the cigarette is usually mixed with a variety of components to obtain aroma, stimulation, saturation, and other inhalation experience, and volatilization rates of different components are different at different temperatures. When the existing smoking cigarette device is used to heat the cigarette, because a temperature distribution inside the cigarette is relatively uniform, the volatilization of cigarette components is unvarying. Consumers tend to feel no obvious changes in the types and content of smoke components during inhalation, and as a result the inhalation experience of the consumers is affected to some extent.

### SUMMARY

This application provides an aerosol generation device and an infrared heater, aimed to resolve the problem of unvarying volatilization of cigarette components during heating of a cigarette in an existing cigarette device.

A first aspect of this application provides an aerosol generation device, configured to heat an aerosol-forming substrate to generate an aerosol for inhalation, and including:

a cavity, configured to receive the aerosol-forming substrate; and

at least one infrared heater, configured to radiate an infrared ray to the cavity to heat the aerosol-forming substrate, where

the infrared heater includes a plurality of infrared heating regions for heating different portions of the aerosol-forming substrate, and a preset pitch is kept between adjacent infrared heating regions; and the plurality of infrared heating regions are configured to be dependently started.

According to a second aspect of this application, an infrared heater for an aerosol generation device is provided, where the infrared heater includes a plurality of infrared heating regions for heating different portions of an aerosol-forming substrate, and a preset pitch is kept between adjacent infrared heating regions; and the plurality of infrared heating regions are configured to be dependently started.

In the aerosol generation device and the infrared heater provided in this application, the plurality of infrared heating regions are dependently started to heat different portions of the aerosol-forming substrate. Because the preset pitch is kept between adjacent infrared heating regions, there are obvious temperature differences between portions of the aerosol-forming substrate corresponding to the infrared heating regions and portions of the aerosol-forming substrate corresponding to the preset pitches, thereby avoiding the problem of unvarying volatilization of cigarette components and improving the inhalation experience of users.

### BRIEF DESCRIPTION OF THE DRAWINGS

One or more embodiments are described by way of example with reference to the corresponding figures in the accompanying drawings, and the exemplary descriptions are not to be construed as limiting the embodiments. Elements/modules and steps in the accompanying drawings that have same reference numerals are represented as similar elements/modules and steps, and unless otherwise particularly stated, the figures in the accompanying drawings are not drawn to scale.

FIG. 1 is a schematic diagram of an aerosol generation device according to an implementation of this application;

FIG. 2 is a schematic exploded view of an aerosol generation device according to an implementation of this application;

FIG. 3 is a schematic diagram of an infrared heater according to an implementation of this application;

FIG. 4 is a schematic diagram of the effect of heating a cigarette by an infrared heater according to an implementation of this application;

FIG. 5 is a schematic diagram of another infrared heater according to an implementation of this application;

FIG. 6 is a schematic diagram of the effect of heating a cigarette by another infrared heater according to an implementation of this application;

FIG. 7 is a schematic diagram of still another infrared heater according to an implementation of this application;

FIG. 8 is a partially unfolded schematic diagram of still another infrared heater according to an implementation of this application;

FIG. 9 is a schematic diagram of still another infrared heater according to an implementation of this application;

FIG. 10 is a schematic cross-sectional view of a part of components of an aerosol generation device according to an implementation of this application;

FIG. 11 is a schematic diagram of an electrode connector according to an implementation of this application; and

FIG. 12 is a schematic diagram of a base according to an implementation of this application.

### DETAILED DESCRIPTION

For ease of understanding of this application, this application is described below in more detail with reference to accompanying drawings and specific implementations. It is to be noted that, when an element is described to be “fixed to” another element, that is, the element can be directly on the another element or there can be one or more intervening elements on the another element. When an element is described to be “connected to” another element, that is, the element can be directly connected to the another element or there can be one or more intervening elements on the another element. The terms “above”, “below”, “left”, “right”, “inside”, “outside”, and similar expressions used in this specification are merely used for an illustrative purpose.

Unless otherwise defined, all technical and scientific terms used herein have the same meaning as commonly understood by one of ordinary skill in the art to which this application belongs. Terms used in the specification of this application are merely intended to describe objectives of the specific embodiments, but are not intended to limit this application. A term “and/or” used in this specification includes any or all combinations of one or more related listed items.

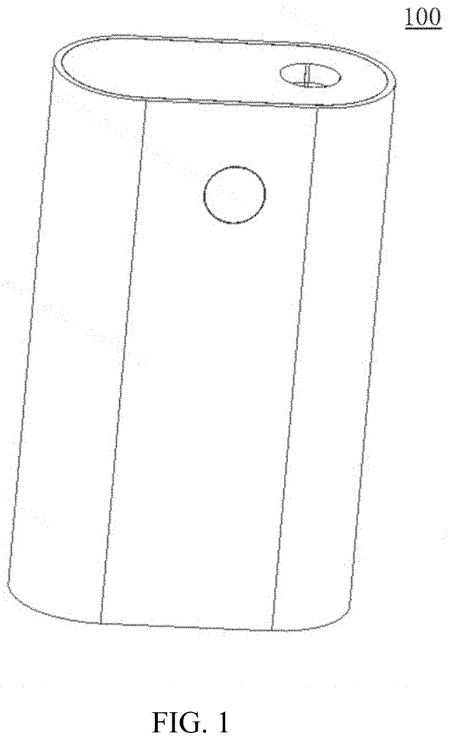

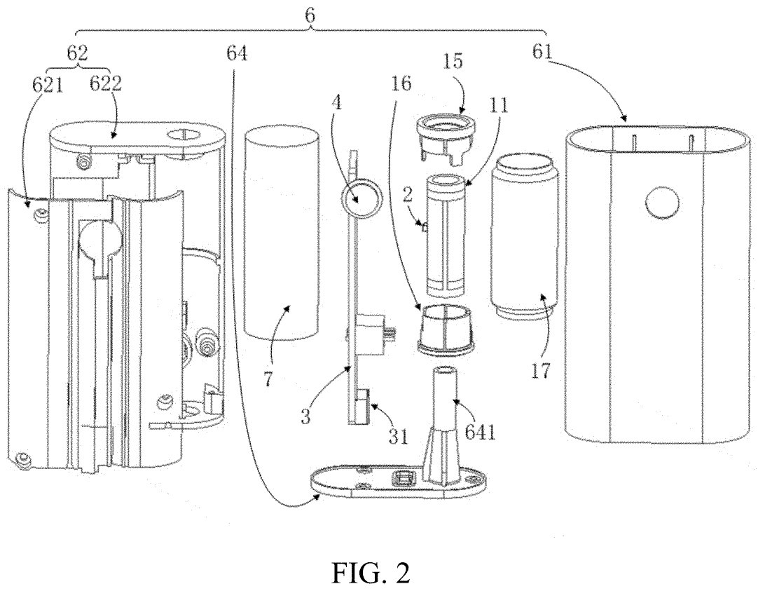

FIG. 1 and FIG. 2 show an aerosol generation device 100 provided according to an implementation of this application, which includes a housing 6 and an infrared heater. The infrared heater is arranged in the housing 6. In the infrared heater of this embodiment, a plurality of infrared electrothermal coatings are disposed on an outer surface of the base body 11 to form a plurality of infrared heating regions. The plurality of infrared electrothermal coatings are configured to be dependently started. For example, the plurality of infrared electrothermal coatings are connected in a current loop in parallel or series, so that the plurality of infrared electrothermal coatings emit infrared rays to radially heat different portions of an aerosol-forming substrate in a cavity of the base body 11 during the passage of a current. Preset pitches are kept between the plurality of infrared electrothermal coatings, so that there are obvious temperature differences between portions of the aerosol-forming substrate corresponding to the infrared electrothermal coatings and portions of the aerosol-forming substrate corresponding to the preset pitches, thereby avoiding the problem of unvarying volatilization of cigarette components and improving the inhalation experience of users.

The housing 6 includes a shell 61, a fixing shell 62, a base, and a bottom cap 64. Both the fixing shell 62 and the base are fixed in the shell 61. The base is configured to fix a base body 11. The base is arranged in the fixing shell 62. The bottom cap 64 is arranged at one end of the shell 61 and covers the shell 61.

Specifically, the base includes a base 15 sleeved at a first end A of the base body 11 and a base 16 sleeved at a second end B of the base body 11. The base 15 and the base 16 are arranged in the fixing shell 62. An air inlet pipe 641 is arranged protruding from the bottom cap 64. An end of the base 16 facing away from the base 15 is connected to the air inlet pipe 641. The base 15, the base body 11, the base 16, and the air inlet pipe 641 are coaxially arranged. The base body 11 can be sealed with the base 15 and the base 16. The base 16 can also be sealed with the air inlet pipe 641. The air inlet pipe 641 is in communication with external air to facilitate smooth air intake during inhalation by a user.

The aerosol generation device 100 further includes a main control circuit board 3 and a battery 7. The fixing shell 62 includes a front shell 621 and a rear shell 622. The front shell 621 is fixedly connected to the rear shell 622. The main control circuit board 3 and the battery 7 are both arranged in the fixing shell 62. The battery 7 is electrically connected to the main control circuit board 3. A button 4 is arranged protruding from the shell 61. An infrared electrothermal coating on a surface of the base body 11 may be energized or de-energized by pressing the button 4. The main control circuit board 3 is further connected to a charging interface 31. The charging interface 31 is exposed from the bottom cap 64. The user may charge or upgrade the aerosol generation device 100 through the charging interface 31, to ensure continuous use of the aerosol generation device 100.

The aerosol generation device 100 further includes a heat insulation tube 17. The heat insulation tube 17 is arranged in the fixing shell 62. The heat insulation tube 17 is arranged in a periphery of the base body 11. The heat insulation tube 17 can prevent a large amount of heat from being transferred to the shell 61 to keep the user's hand from a thermal burn. The heat insulation tube includes a heat insulation material. The heat insulation material may be heat insulation glue, aerogel, aerogel felt, asbestos, aluminum silicate, calcium silicate, diatomite, or zirconium oxide. The heat insulation tube 17 may be a vacuum heat insulation tube. An infrared ray reflective coating may be further formed in the heat insulation tube 17, to reflect an infrared ray emitted by the infrared electrothermal coating on the base body 11 to the infrared electrothermal coating, thereby improving heating efficiency.

The aerosol generation device 100 further includes a temperature sensor 2, such as an NTC temperature sensor, configured to detect a real-time temperature of the base body 11 and transmit the detected real-time temperature to the main control circuit board 3. The main control circuit board 3 adjusts the magnitude of a current flowing through the infrared electrothermal coating according to the real-time temperature.

Specifically, when the NTC temperature sensor detects that the real-time temperature in the base body 11 is relatively low, for example, detects that a temperature on an inner side of the base body 11 is below 150° C., the main control circuit board 3 controls the battery 7 to output a relatively high voltage to a conductive element, to further increase a current fed into the infrared electrothermal coating, thereby increasing a heating power of the aerosol-forming substrate, and reducing a time for the user to wait to inhale the first puff.

When the NTC temperature sensor detects that the temperature of the base body 11 ranges from 150° C. to 200° C., the main control circuit board 3 controls the battery 7 to output a normal voltage to the conductive element.

When the NTC temperature sensor detects that the temperature of the base body 11 ranges from 200° C. to 250° C., the main control circuit board 3 controls the battery 7 to output a relatively low voltage to the conductive element.

When the NTC temperature sensor detects that the temperature on the inner side of the base body 11 is 250° C. or higher, the main control circuit board 3 controls the battery 7 to stop outputting a voltage to the conductive element.

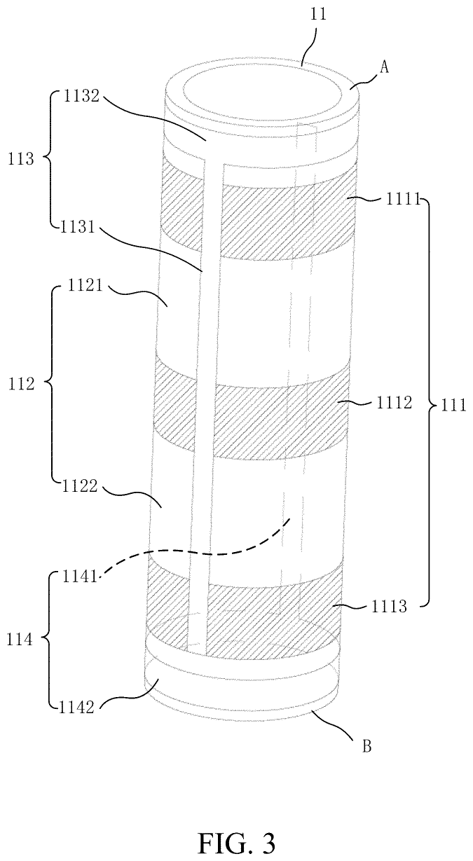

FIG. 3 is a schematic diagram of another infrared heater according to an implementation of this application. The infrared heater includes:

a base body 11, configured in a tubular shape extending in an axial direction of a cavity and surrounding the cavity. The cavity is configured to receive an aerosol-forming substrate.

Specifically, the base body 11 includes a first end (or a near end) A and a second end (or a far end) B and a surface extending between the first end A and the second end B. The base body 11 may be in a shape of a cylinder, a prism, or another column, or non-column (for example, plate-shaped). Preferably, the base body 11 is in a shape of a cylinder. The cavity is a cylindrical hole running through a middle part of the base body 11. An inner diameter of the hole is slightly greater than an outer diameter of an aerosol-forming product, so that the aerosol-forming product may be placed in the cavity for heating.

The base body 11 may be made of a high temperature-resistant and transparent material, and may be made of another material with a relatively high infrared transmittance, for example, a high temperature-resistant material with an infrared transmittance above 95%. This is not specifically limited herein.

The aerosol-forming substrate is a substrate that can release volatile compounds that can form an aerosol. The volatile compounds may be released by heating the aerosol-forming substrate. The aerosol-forming substrate may be a solid or a liquid or include solid and liquid components. The aerosol-forming substrate may be loaded on a carrier or a support through adsorption, coating, impregnation, or another manner. The aerosol-forming substrate may conveniently be a part of the aerosol-forming product.

The aerosol-forming substrate may include nicotine. The aerosol-forming substrate may include tobacco, for example, may include a tobacco-containing material including volatile tobacco aroma compounds. The volatile tobacco aroma compounds are released from the aerosol-forming substrate when heated. Preferably, the aerosol-forming substrate may include a homogeneous tobacco material such as leaf tobacco. The aerosol-forming substrate may include at least one aerosol-forming agent, and the aerosol-forming agent may be any appropriate known compound or a mixture of compounds. During use, the compound or the mixture of compounds facilitates and stabilizes formation of the aerosol and is substantially resistant to thermal degradation at an operating temperature of an aerosol-forming system. The appropriate aerosol-forming agent is well known in the art, and includes, but not limited to: polyol, such as triethylene glycol, 1,3-butanediol, and glycerin; polyol ester, such as monoglyceride and diacetate or triacetate; and monobasic carboxylic acid, dibasic carboxylic acid, and polybasic carboxylic acid fatty acid ester, such as dimethyl dodecane dibasic ester and dimethyl tetradecane dibasic ester. Preferably, the aerosol-forming agent is polyhrdric ester or a mixture thereof, such as triethylene glycol, 1,3-butanediol, or most preferably, glycerol.

The infrared electrothermal coating 111 is formed on the surface of the base body 11. The infrared electrothermal coating 111 may be formed on an outer surface of the base body 11, or may be formed on an inner surface of the base body 11.

In this example, the outer surface of the base body 11 includes three coating regions arranged at intervals in an axial direction of the cavity. Adjacent coating regions are spaced by a non-coating region 112 to keep a preset pitch.

Specifically, a first infrared electrothermal coating 1111, a second infrared electrothermal coating 1112, and a third infrared electrothermal coating 1113 are respectively arranged in the three coating regions. The first infrared electrothermal coating 1111 and the second infrared electrothermal coating 1112 are spaced by a first non-coating region 1121, and the second infrared electrothermal coating 1112 and the third infrared electrothermal coating 1113 are spaced by a second non-coating region 1122.

In this example, lengths of the first non-coating region 1121 and the second non-coating region 1122 in the axial direction range from 2 mm to 10 mm, preferably 2 mm to 8 mm, further preferably 3 mm to 8 mm, further preferably 4 mm to 8 mm, further preferably 5 mm to 8 mm, and further preferably 5 mm to 7 mm. It should be noted that, the length of the first non-coating region 1121 in the axial direction and the length of the second non-coating region 1122 in the axial direction may be the same or different.

The lengths of the first infrared electrothermal coating 1111, the second infrared electrothermal coating 1112, and the third infrared electrothermal coating 1113 in the axial direction may be the same or different, and equivalent resistances thereof may be the same or different. For example, the lengths of the first infrared electrothermal coating 1111 and the third infrared electrothermal coating 1113 in the axial direction may be set smaller than the length of the second infrared electrothermal coating 1112 in the axial direction, so that the equivalent resistances of the first infrared electrothermal coating 1111 and the third infrared electrothermal coating 1113 are smaller than the equivalent resistance of the second infrared electrothermal coating 1112. In this way, after the infrared electrothermal coating 111 receives an electric power, higher current density and more heat are generated at two ends of the base body 11, and temperature compensation at the two ends of the base body can be implemented. In addition, a wait time for smoke discharge can be shortened by setting a smaller equivalent resistance of the first infrared electrothermal coating 1111, and the inhalation experience of users can be further improved.

The infrared electrothermal coating 111 receives the electric power to generate heat, thereby generating an infrared ray of a certain wavelength, for example, a far-infrared ray of 8 μm to 15 μm. When the wavelength of the infrared ray matches an absorption wavelength of the aerosol-forming substrate, the energy of the infrared ray is easily absorbed by the aerosol-forming substrate. The wavelength of the infrared ray is not limited, which may be an infrared ray of 0.75 μm to 1000 μm, preferably a far-infrared ray of 1.5 μm to 400 μm. In this example, the first infrared electrothermal coating 1111, the second infrared electrothermal coating 1112, and the third infrared electrothermal coating 1113 are configured to dependently receive the electric power of a power supply to generate heat and then generate infrared rays, so as to radially heat different parts of the aerosol-forming substrate.

The infrared electrothermal coating 111 is preferably obtained by fully and uniformly stirring a far-infrared electrothermal ink, ceramic powder, and an inorganic binder, coating the mixture on the outer surface of the base body 11, and then performing drying and curing for a certain time. The thickness of the infrared electrothermal coating 111 is 30 μm to 50 μm. Certainly, the infrared electrothermal coating 111 may be obtained by mixing and stirring tin tetrachloride, tin oxide, antimony trichloride, titanium tetrachloride, and anhydrous copper sulfate in certain proportions and coating the mixture on the outer surface of the base body 11, or is one of a silicon carbide ceramic layer, a carbon fiber layer, a carbon fiber composite layer, a zirconium titanium oxide ceramic layer, a zirconium titanium nitride ceramic layer, a zirconium titanium boride ceramic layer, a zirconium titanium carbide ceramic layer, an iron oxide ceramic layer, an iron nitride ceramic layer, an iron boride ceramic layer, an iron carbide ceramic layer, a rare earth oxide ceramic layer, a rare earth nitride ceramic layer, a rare earth boride ceramic layer, a rare earth carbide ceramic layer, a nickel cobalt oxide ceramic layer, a nickel cobalt nitride ceramic layer, a nickel cobalt boride ceramic layer, a nickel cobalt carbide ceramic layer or a high silica molecular sieve ceramic layer. The infrared electrothermal coating may be a coating of another material, such as a derivative and compound with carbon as part or all of constituent elements, including but is not limited to, carbon nanotubes, a carbon nanotube film, graphene, carbon fiber, a carbon fiber film, a carbon film, and a carbon fiber sheet.

The conductive element is configured to supply power dependently to the first infrared electrothermal coating 1111, the second infrared electrothermal coating 1112, and the third infrared electrothermal coating 1113.

In this example, the conductive element includes a first electrode 113 and a second electrode 114 arranged at an interval on the base body 11. The first electrode 113 and the second electrode 114 are both conductive coatings. The conductive coating may be a metal coating or a conductive tape. The metal coating may be made of silver, gold, palladium, platinum, copper, nickel, molybdenum, tungsten, niobium or an alloy of the foregoing metal. The first electrode 113 and second electrode 114 are at least partially overlapped with the first infrared electrothermal coating 1111, the second infrared electrothermal coating 1112, and the third infrared electrothermal coating 1113 to form an electrical connection to feed an electrical power to the first infrared electrothermal coating 1111, the second infrared electrothermal coating 1112, and the third infrared electrothermal coating 1113.

In this example, the first electrode 113 includes a coupling portion 1132 and a conductive portion 1131 extending axially from the coupling portion 1132 toward a second end B. The coupling portion 1132 extends in a circumferential direction of the base body 11 to form an annular electrode. The conductive portion 1131 is at least partially overlapped with the first infrared electrothermal coating 1111, the second infrared electrothermal coating 1112, and the third infrared electrothermal coating 1113 to form an electrical connection. The coupling portion 1132 is not overlapped with, that is, is spaced apart from the first infrared electrothermal coating 1111, the second infrared electrothermal coating 1112, and the third infrared electrothermal coating 1113.

The second electrode 114 includes a coupling portion 1142 and a conductive portion 1141 extending axially from the coupling portion 1142 toward a first end A. The coupling portion 1142 extends in the circumferential direction of the base body 11 to form the annular electrode. The conductive portion 1141 is at least partially overlapped with the first infrared electrothermal coating 1111, the second infrared electrothermal coating 1112, and the third infrared electrothermal coating 1113 to form an electrical connection. The coupling portion 1142 is not overlapped with the first infrared electrothermal coating 1111, the second infrared electrothermal coating 1112, and the third infrared electrothermal coating 1113.

It should be noted that, in other examples, the coupling portion 1132 and the coupling portion 1142 extending in the circumferential direction of the base body 11 may form an arc-shaped electrode, that is, an electrode in a shape other than a closed ring. The coupling portion 1132 and the coupling portion 1142 may be disposed at the same end of the base body 11, for example, immediately adjacent to the second end B.

The conductive portion 1131 and the conductive portion 1141 are disposed symmetrically along a central axis of the base body 11. In this way, when the coupling portion 1132 and the coupling portion 1142 are coupled with the power supply, for example, the coupling portion 1132 is coupled to a positive electrode of the power supply, and the coupling portion 1142 is coupled to a negative electrode of the power supply, a current may flow into the conductive portion 1131 and circumferentially flow through the first infrared electrothermal coating 1111, the second infrared electrothermal coating 1112, and the third infrared electrothermal coating 1113 to reach the conductive portion 1141, so that the first infrared electrothermal coating 1111, the second infrared electrothermal coating 1112, and the third infrared electrothermal coating 1113 simultaneously radiate infrared rays to the cavity to heat different portions of the aerosol-forming substrate.

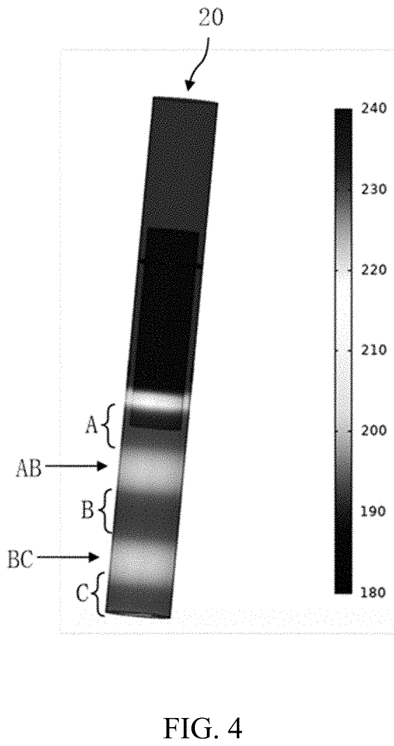

FIG. 4 is a schematic diagram of the effect of heating a cigarette 20 by the infrared heater shown in FIG. 3. As shown in FIG. 4, the first infrared electrothermal coating 1111 radially heats a portion A of the cigarette, the second infrared electrothermal coating 1112 radially heats a portion B of the cigarette, and the third infrared electrothermal coating 1113 radially heats a portion C of the cigarette. A portion AB of the cigarette corresponds to the first non-coating region 1121. A portion BC of the cigarette corresponds to the second non-coating region 1122. The heat for the portion AB and the portion BC of the cigarette mainly comes from thermal conduction of the base body 11 and thermal conduction of adjacent portions.

As can be seen from FIG. 4, there is an obvious temperature difference between the portion A of the cigarette and the portion AB of the cigarette. The temperature difference may be controlled between 40° C. and 80° C. In this example, the temperature difference is controlled at about 60° C. A temperature difference between the portion B of the cigarette and the portion AB or the portion BC of the cigarette is similar to the temperature difference between the portion C of the cigarette and the portion BC of the cigarette. The temperature difference can avoid the problem of unvarying volatilization of cigarette components, thereby improving the inhalation experience of users.

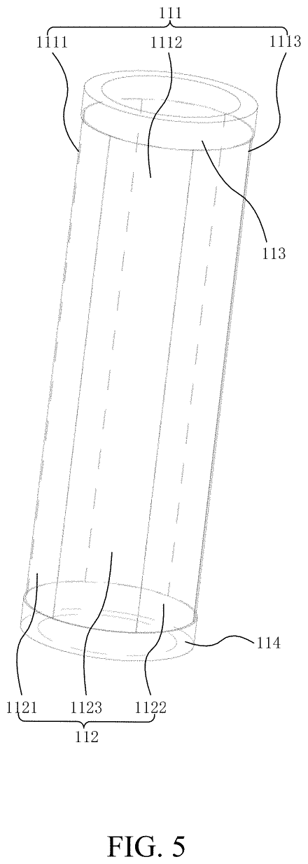

FIG. 5 is a schematic diagram of another infrared heater according to an implementation of this application. Differences from FIG. 3 lie in that an outer surface of the base body 11 includes three coating regions arranged at intervals in a circumferential direction of a cavity. A first infrared electrothermal coating 1111, a second infrared electrothermal coating 1112, and a third infrared electrothermal coating 1113 are respectively arranged in three coating regions. The first infrared electrothermal coating 1111 and the second infrared electrothermal coating 1112 are spaced by the first non-coating region 1121. The second infrared electrothermal coating 1112 and the third infrared electrothermal coating 1113 are spaced by the second non-coating region 1122. The third infrared electrothermal coating 1113 and the first infrared electrothermal coating 1111 are spaced by the third non-coating region 1123. Each of the first electrode 113 and the second electrode 114 extends in the circumferential direction of the base body 11 to form an annular electrode (or an arc-shaped electrode). When the first electrode 113 and the second electrode 114 are coupled to the power supply. For example, the first electrode 113 is coupled to the positive electrode of the power supply. The second electrode 114 is coupled to the negative electrode of the power supply. A current flows axially from the first electrode 113 through the first infrared electrothermal coating 1111, the second infrared electrothermal coating 1112, and the third infrared electrothermal coating 1113 to the second electrode 114, so that the first infrared electrothermal coating 1111, the second infrared electrothermal coating 1112, and the third infrared electrothermal coating 1113 simultaneously radiate infrared rays to the cavity to heat different portions of the aerosol-forming substrate.

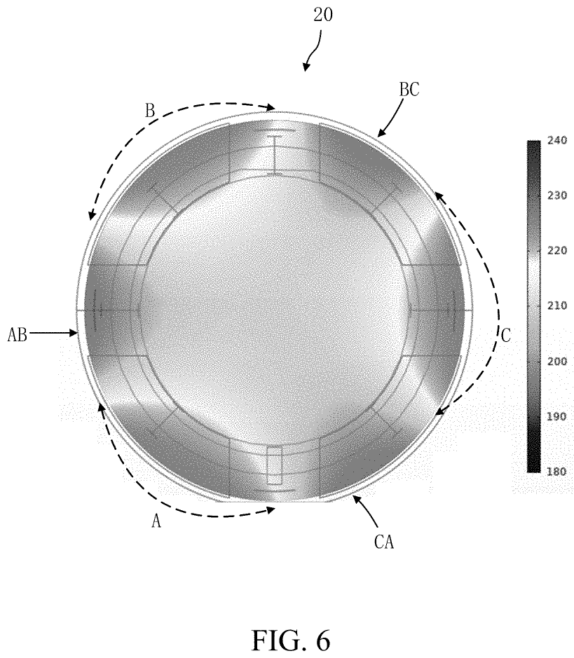

FIG. 6 is a schematic diagram of the effect of heating a cigarette 20 by the infrared heater shown in FIG. 5. Similar to the foregoing, there are obvious temperature differences between the portion A of the cigarette and the portion AB or the portion CA of the cigarette, between the portion B of the cigarette and the portion AB or the portion BC of the cigarette, and between the portion C of the cigarette and the portion CA or the portion BC of the cigarette.

It should be noted that the foregoing parts are described in terms of an infrared electrothermal coating. In other embodiments, a plurality of infrared heating regions of the infrared heater may be formed by an infrared radiation layer through thermal excitation or by a film configuration that can be wound on the base body 11.

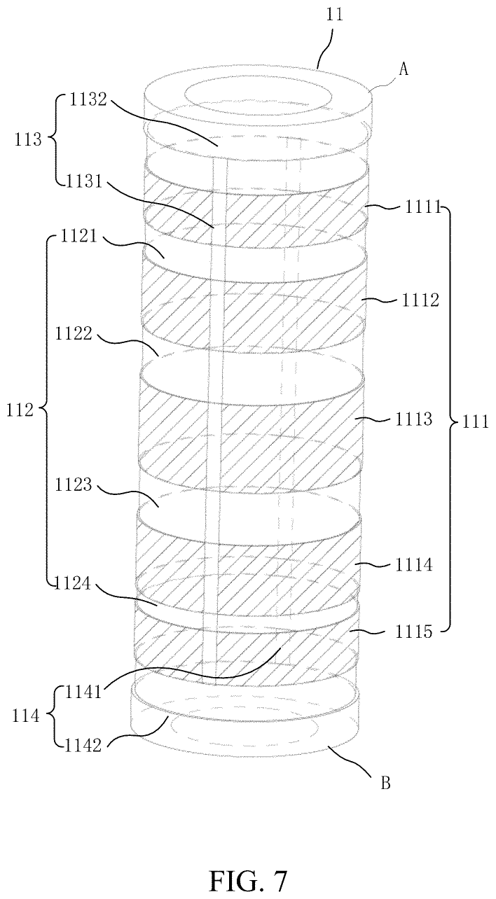

FIG. 7 is a schematic diagram of still another infrared heater according to an implementation of this application. Differences from FIG. 3 lie in that an outer surface of the base body 11 includes five coating regions arranged at intervals in a circumferential direction of a cavity. A first infrared electrothermal coating 1111, a second infrared electrothermal coating 1112, a third infrared electrothermal coating 1113, a fourth infrared electrothermal coating 1114, and a fifth infrared electrothermal coating 1115 are respectively arranged in the five coating regions and are spaced by a first non-coating region 1121, a second non-coating region 1122, a third non-coating region 1123, and a fourth non-coating region 1124. The lengths of the first non-coating region 1121 adjacent to a first end A and the fourth non-coating region 1124 adjacent to a second end B in the axial direction are smaller, while the lengths of the second non-coating region 1122 and the third non-coating region 1123 in the axial direction are larger. In this way, there are obvious temperature differences between portions of the aerosol-forming substrate corresponding to the infrared heating region and portions of the aerosol-forming substrate corresponding to the preset pitches. In addition, higher current density and more heat are generated at both ends of the base body 11, and temperature compensation can be implemented at two ends of the base body. It should be noted that, in this example, the lengths of the first infrared electrothermal coating 1111, the second infrared electrothermal coating 1112, the third infrared electrothermal coating 1113, the fourth infrared electrothermal coating 1114, and the fifth infrared electrothermal coating 1115 in the axial direction may be different.

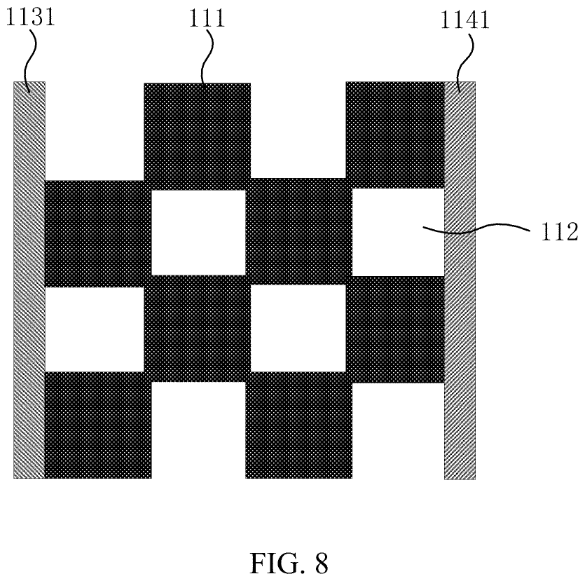

FIG. 8 is a partially unfolded schematic diagram of still another infrared heater according to an implementation of this application. Differences from FIG. 3 lie in that an outer surface of the base body 11 includes a plurality of coating regions and a plurality of non-coating regions 112. A plurality of infrared electrothermal coatings 111 are disposed in the plurality of coating regions. The plurality of infrared electrothermal coatings 111 and the plurality of non-coating regions 112 form a mesh structure together. The conductive portion 1131 and the conductive portion 1141 are overlapped with a portion of the infrared electrothermal coating 111 to form an electrical connection.

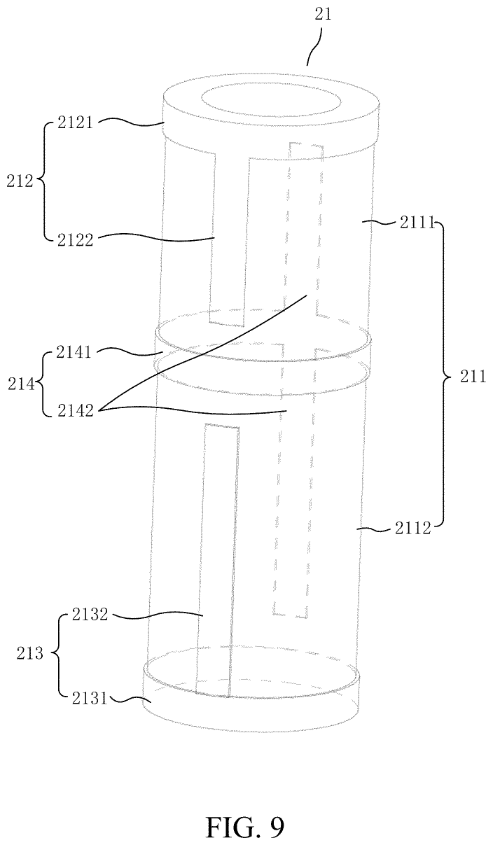

FIG. 9 is a schematic diagram of still another infrared heater according to an implementation of this application. As shown in FIG. 9, the infrared heater includes an infrared electrothermal coating 211, a first electrode 212, a second electrode 213, and a third electrode 214 that are formed on a base body 21. The infrared electrothermal coating 211 is spaced in the axial direction of the outer surface of the base body 21 by a first infrared electrothermal coating 2111 and a second infrared electrothermal coating 2112. The first electrode 212 includes a coupling portion 2121 and a conductive portion 2122. The second electrode 213 includes a coupling portion 2131 and a conductive portion 2132. The third electrode 214 includes a coupling portion 2141 and a conductive portion 2142. The first infrared electrothermal coating 2111 and the second infrared electrothermal coating 2112 may be controlled to start independently to implement segmented heating through the arrangement of the first electrode 212, the second electrode 213, and the third electrode 214.

In this example, the first infrared electrothermal coating 2111 and the second infrared electrothermal coating 2112 are equivalent to two independent infrared heaters. A plurality of infrared heating regions can be constructed in each part according to a manner in FIG. 3 or FIG. 7, so that there are obvious temperature differences between portions of the aerosol-forming substrate corresponding to the infrared heating regions and portions of the aerosol-forming substrate corresponding to the preset pitches, thereby avoiding the problem of unvarying volatilization of cigarette components and improving the inhalation experience of users. It is readily conceivable that the same can be achieved for a plurality of independently started infrared electrothermal coatings spaced in the circumferential direction of the outer surface of the base body 21. It should be noted that the structure of the segmented heating is not limited to the case shown in FIG. 9.

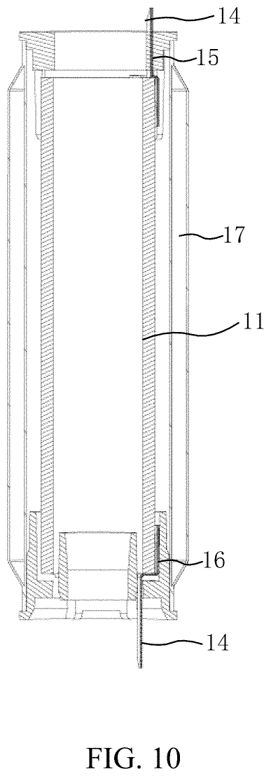

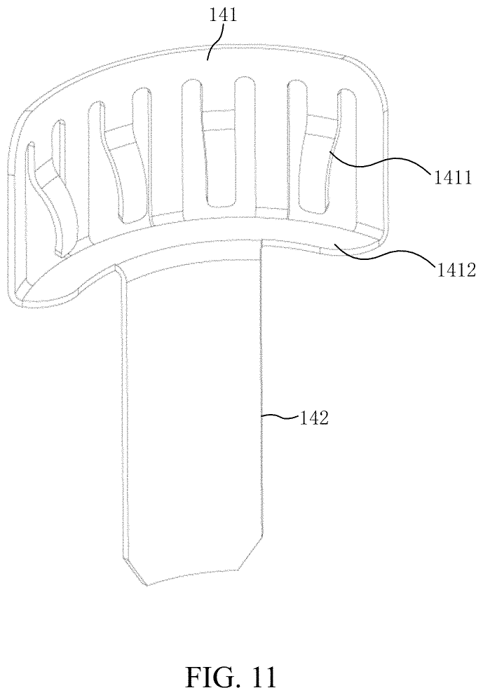

Referring to FIG. 10 to FIG. 12, the aerosol generation device 100 further includes an electrode connector 14. The electrode connector 14 is electrically connected to the first electrode 113 and the second electrode 114, and the first electrode 113 and the second electrode 114 respectively extend to positions away from the base body 11.

An electrode connector 14 electrically connected to the second electrode 114 used as an example for description below:

The electrode connector 14 includes a contact portion and an extending portion 142. At least a part of the contact portion protrudes toward the outer surface of the base body 11 to contact the coupling portion 1142 to form an electrical connection. The extending portion 142 extends toward a position away from the base body 11 relative to the contact portion. The extending portion 142 is configured to be coupled to a power supply.

The contact portion includes a body 141 and four cantilevers 1411 extending from the body 141. The four cantilevers 1411 protrude from a surface of one side of the body 141. In this way, when the cantilever 1411 abuts against the coupling portion 1142, an elastic force can be generated to implement the electrical connection with the coupling portion 1142. The extending portion 142 extends from the body 141 toward a position away from the base body 11.

The shape of the body 141 matches the shape of an end portion of the base body 11. Specifically, the body 141 is formed in an arc shape. The body 141 has an abutting portion 1412 extending radially. The arc-shaped body 141 abuts against an end portion surface of the base body 11. The abutting portion 1412 abuts against an end portion of the base body 11 to provide a limiting position for limiting a relative position of the contact portion and the base body 11, so that the cantilever 1411 is located at the coupling portion 1142.

Four cantilevers 1411 are arranged at intervals on the body 141 in the circumferential direction of the base body 11. In other examples, a quantity of the cantilevers 1411 is not limited. More or fewer than four cantilevers may be provided. It may be understood that a plurality of cantilevers 1411 are helpful for reliable electrical connection of electrodes but increase processing costs. A flexible selection may be made by those skilled in the art as required.

The aerosol generation device 100 further includes a base 15 sleeved on a first end A and a base 16 sleeved on a second end B. The base 15 and the base 16 are made of an insulating, high temperature-resistant, and thermal insulation material.

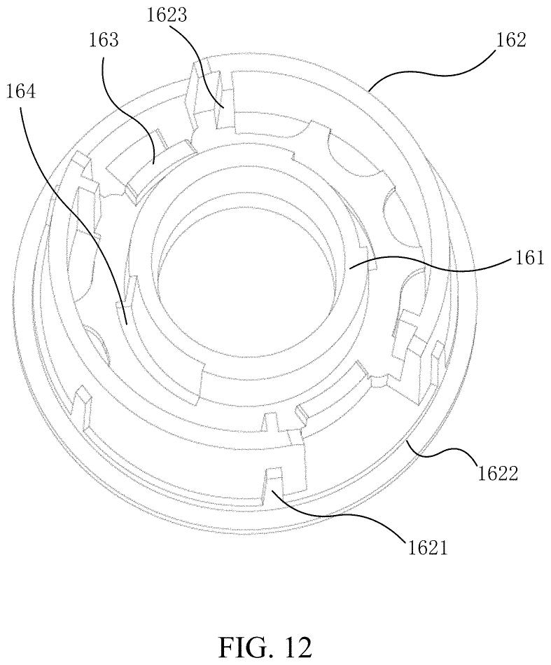

The base 15 and the base 16 may have the same structure. Specifically, as shown in FIG. 12, the base 16 includes an inner cylinder 161 and an outer cylinder 162. The base body 11 is detachably sleeved between an outer wall of the inner cylinder 161 and an inner wall of the outer cylinder 162. The inner cylinder 161 has a hollow tubular shape. Air flows to the cavity of the base body 11 through the inner cylinder 161. A length of the inner cylinder 161 in the axial direction is slightly larger than a length of the coupling portion 1142 in the axial direction. A plurality of bosses 1621 distributed in a circumferential direction and extending toward a heat insulation tube 17 are provided on an outer wall of the outer cylinder 162. An end portion of the outer cylinder 162 includes an abutting portion 1622 extending in a radial direction. During assembly with the heat insulation tube 17, the bosses 1621 and an abutting portion 1622 are arranged, so that the end portion of the heat insulation tube 17 can abut against the abutting portion 1622, and a certain gap is provided between an inner wall of the heat insulation tube 17 and the outer wall of the outer cylinder 162 to facilitate the inflow of cool air. A plurality of holding portions 1623 distributed at intervals are further provided on the inner wall of the outer cylinder 162. The plurality of holding portions 1623 extend from the inner wall of the outer cylinder 162 to toward the inner cylinder 161. When the base body 11 is sleeved on the base 16, the holding portions 1623 abut against an outer surface of the base body 11 to hold the end portion of the base body 11.

The base 16 is further provided with a circumferential stop portion for preventing the rotation of the base body 11. The circumferential stop portion includes a positioning protrusion 163 disposed protruding from a side of the base 16 facing the base body 11. A positioning notch corresponding to and matching the positioning protrusion 163 is opened in a tube wall of the base body 11. When the base body 11 is sleeved on the base 16, the positioning protrusion 163 matches a buckle corresponding to the positioning notch, so as to prevent the base body 11 from rotating in the circumferential direction relative to the base 16. The base 16 is also provided with a through hole 164 for leading out the extending portion 142 of the electrode connector 14.

It should be noted that, this specification of this application and the accompanying drawings thereof illustrate preferred embodiments of this application. However, this application can be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the above technical features may further be combined to form various embodiments not listed above, and all such embodiments shall be construed as falling within the scope of the specification of this application. Further, a person of ordinary skill in the art may make improvements and variations according to the above descriptions, and such improvements and variations shall all fall within the protection scope of the appended claims of this application.

1. An aerosol generation device, configured to heat an aerosol-forming substrate to generate an aerosol for inhalation, and comprising:
a cavity, configured to receive the aerosol-forming substrate; and
at least one infrared heater, configured to radiate an infrared ray to the cavity to heat the aerosol-forming substrate, wherein:
the infrared heater comprises a plurality of infrared heating regions for heating different portions of the aerosol-forming substrate, and a preset pitch is kept between adjacent infrared heating regions; and the plurality of infrared heating regions are configured to be dependently started.

2. The aerosol generation device according to claim 1, wherein the infrared heater comprises:
a base body, provided with a surface; and
a plurality of infrared radiation layers, arranged at intervals on the surface, wherein the plurality of infrared radiation layers form the plurality of infrared heating regions.

3. The aerosol generation device according to claim 2, wherein the plurality of infrared radiation layers are coatings formed on the base body;
the surface comprises a plurality of coating regions, and the plurality of infrared radiation layers are respectively arranged in the plurality of coating regions; and non-coating regions are arranged between adjacent coating regions, so that the preset pitch is kept between the adjacent infrared heating regions.

4. The aerosol generation device according to claim 2, wherein the plurality of infrared radiation layers are films capable of being wound on the base body.

5. The aerosol generation device according to claim 2, wherein the infrared heater further comprises a conductive element for supplying power to the plurality of infrared radiation layers dependently.

6. The aerosol generation device according to claim 5, wherein the conductive element comprises a first electrode and a second electrode arranged at an interval on the base body, and the first electrode and the second electrode are both at least partially overlapped with the plurality of infrared radiation layers to form an electrical connection.

7. The aerosol generation device according to claim 6, wherein the base body is configured in a tubular shape extending in an axial direction of the cavity and surrounding the cavity; and
the plurality of infrared radiation layers are arranged at intervals in the axial direction of the cavity or the plurality of infrared radiation layers form a mesh structure, each of the first electrode and the second electrode comprises a conductive portion, and the conductive portion is configured to extend in the axial direction of the cavity and is at least partially overlapped with the plurality of infrared radiation layers to form the electrical connection.

8. The aerosol generation device according to claim 7, wherein the first electrode and/or the second electrode further comprises a coupling portion electrically connected to the conductive portion, and the coupling portion is configured to extend in a circumferential direction of the cavity and is not overlapped with the plurality of infrared radiation layers; and the coupling portion is configured to be coupled to a power supply.

9. The aerosol generation device according to claim 6, wherein the base body is configured in a tubular shape extending in an axial direction of the cavity and surrounding the cavity; and
the plurality of infrared radiation layers are arranged at intervals in a circumferential direction of the cavity, and the first electrode and the second electrode are both configured to extend in the circumferential direction of the cavity to be at least partially overlapped with the plurality of infrared radiation layers and form the electrical connection.

10. The aerosol generation device according to claim 5, wherein the conductive element is a conductive coating formed on the base body.

11. The aerosol generation device according to claim 1, wherein the preset pitch ranges from 2 mm to 10 mm, preferably from 2 mm to 8 mm, further preferably from 3 mm to 8 mm, further preferably from 4 mm to 8 mm, further preferably from 5 mm to 8 mm, and further preferably from 5 mm to 7 mm.

12. The aerosol generation device according to claim 1, wherein the aerosol generation device comprises a first infrared heater and a second infrared heater, and the first infrared heater and the second infrared heater are configured to be independently started to implement segmented heating.

13. An infrared heater for an aerosol generation device, wherein the infrared heater comprises a plurality of infrared heating regions for heating different portions of an aerosol-forming substrate, and a preset pitch is kept between adjacent infrared heating regions; and the plurality of infrared heating regions are configured to be dependently started.

14. The aerosol generation device according to claim 3, wherein the infrared heater further comprises a conductive element for supplying power to the plurality of infrared radiation layers dependently.

15. The aerosol generation device according to claim 14, wherein the conductive element comprises a first electrode and a second electrode arranged at an interval on the base body, and the first electrode and the second electrode are both at least partially overlapped with the plurality of infrared radiation layers to form an electrical connection.

16. The aerosol generation device according to claim 14, wherein the conductive element is a conductive coating formed on the base body.

17. The aerosol generation device according to claim 4, wherein the infrared heater further comprises a conductive element for supplying power to the plurality of infrared radiation layers dependently.

18. The aerosol generation device according to claim 17, wherein the conductive element comprises a first electrode and a second electrode arranged at an interval on the base body, and the first electrode and the second electrode are both at least partially overlapped with the plurality of infrared radiation layers to form an electrical connection.

19. The aerosol generation device according to claim 17, wherein the conductive element is a conductive coating formed on the base body.
